(19) United States
(12) Patent Application Publication
(10) Pub. No.: US 2006/0123849 A1
(43) Pub. Date: Jun. 15, 2006

(54) Method for the production of a ceramic fiber with a metal coating

(75) Inventors: Jaochim Bamberg, Dachau (DE); Wilhelm Satzger, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Muenchen (DE)

(21) Appl. No.: 10/523,811

(22) PCT Filed: Jul. 22, 2003
(86) PCT No.: PCT/EP03/07972

§ 371 Date: Oct. 25, 2005

(30) Foreign Application Priority Data
Aug. 5, 2002 (DE) 102 35 818.4

(51) Int. Cl. C03B 31/00; C23C 4/08

(52) U.S. Cl. 65/44; 427/455

(57) ABSTRACT

A method for producing a reinforcing ceramic fiber with a metal coating. The metal coating is converted to an exterior shape having a polygonal cross section permits a structure of reinforcing fibers to be arranged side-by-side and above one another without leaving any cavities. When the polygonal-shaped fibers are arranged in this manner about a base part and hot pressed, a fiber-reinforced metal matrix component is created without volumetric shrinkage during the hot pressing.

This application claims the priority of German application no. 10235818.4, filed Aug. 5, 2002, and PCT/EP2003/007972 filed Jul. 22, 2003, the disclosure of which is expressly incorporated by reference herein.

### BACKGROUND AND SUMMARY OF THE INVENTION

The present invention relates to a method for producing a ceramic fiber with a metal coating with an exterior shape which permits arrangement of adjacent fibers without gaps therebetween.

Such ceramic fibers with a metal coating are used to produce fiber-reinforced films, sheets or strips with a metal matrix such as those disclosed in U.S. Pat. Nos. 4,733,816 and 4,499,156, for example. The fibers used include silicon carbide fibers, silicon-coated silicon carbide fibers, silicon carbide-coated boron fibers or boron carbide-coated boron fibers. Only titanium-based alloys are available as the matrix material.

The parts made ultimately of fiber-reinforced films, sheets or strips are also known as metal matrix components (MMCs).

The known reinforcing fibers of ceramic fibers with a metal coating have a circular exterior shape in cross section. Both the ceramic fiber in cross section is circular and the metal layer applied to the ceramic fiber is annular in shape. Such reinforcing fibers are wound onto base parts in such a way that multiple reinforcing fibers are applied side-by-side as well as one above the other, resulting in hollow spaces between the reinforcing fibers. After applying the reinforcing fibers, the entirety is consolidated, i.e., by hot isostatic pressing. This results in volume shrinkage and the cavities disappear, leading to resulting fiber migration. In three-dimensional structures, these changes are associated with fiber loads such as bending and breaking and various types of fiber displacement such as fiber disorientation. The uniform exterior arrangement of fibers, however, is of great importance for a high breaking strength and fatigue strength. The known designs with reinforcing fibers therefore result in fatigue cracks, a low breaking strength and a shortened lifetime, among other things, in particular in the case of the metal matrix components (MMCs) produced from the reinforcing fibers.

The object of this invention is to improve upon a method for producing a ceramic fiber with a metal coating such that the disadvantages pointed out above are avoided and an inexpensive method is obtained in which the reinforcing fibers can easily be brought into a predetermined accurate arrangement in relation to one another.

This invention is based on the finding that there are external shapes which permit an alignment of multiple reinforcing fibers side-by-side and one above the other without any hollow spaces. Therefore, subsequent compression molding operations can be performed without the shrinkage of volume which eliminates cavities, thus preventing fiber migration and yielding a precise fiber arrangement over the cross section, e.g., of a metal matrix component (MMC).

According to this invention, the metal coating on the ceramic fiber is converted to an exterior shape having a polygonal cross section which permits an association of reinforcing fibers side-by-side and one above the other in such a tight packing as to eliminate cavities.

In one embodiment of this invention, the exterior polygonal shape is stamped upon the metal layer by cold rolling. For example, one roller may be assigned to each face or it is also possible to provide profiled rollers which together form the polygonal profile. In particular, the polygonal profile of the exterior shape of the reinforcing fibers is designed to have a hexagonal cross section.

The ceramic fiber is preferably first provided with a metal coating and then the exterior polygonal shape is stamped upon it. Therefore, traditional reinforcing fibers can be used because the polygonal exterior shape is stamped upon them only subsequently. As a rule, the traditional reinforcing fibers have a round exterior shape. Likewise, ceramic fibers have a round exterior shape.

The metal coating is provided in a thickness which is essentially constant over the circumference before stamping.

The metal layer is applied to the ceramic fiber in particular in a PVD method (physical vapor deposition) or by rolling a metal wire onto the red hot ceramic fiber under a protective gas atmosphere.

According to one embodiment of the invention, titanium, in particular Ti64 is used as the metal coating.

In particular the ceramic fibers include essentially the elements silicon (Si), carbon (C), boron (B), oxygen (O), aluminum (Al) and/or nitrogen (N).

The reinforcing fibers are used mainly for the production of metal matrix components (MMCs).

According to one embodiment of the invention, the reinforcing fibers are used to produce a semifinished product. In this process, the ceramic fiber is wound onto a base part without any cavities. This is readily possible due to the polygonal exterior shape. The coiling process with the polygonal exterior shape of the reinforcing fibers produces an identical receiving groove for the next layer of winding. This yields dimensionally accurate contact surfaces even when there are fluctuations in the metal layer. A precise geometric fiber arrangement without any accumulation of defects is obtained. Furthermore it is readily possible to check on the winding in the grooves—reflective surface.

In order to achieve a precise arrangement of even the bottom layer of reinforcing fibers on the base part, the base part has grooves on its surface into which the ceramic fibers are laid.

After winding the reinforcing fibers onto the base part, a hot isostatic pressing process is performed. Due to the winding without any cavities, the hot isostatic pressing process can be performed without volume shrinkage. Therefore there is no migration of fibers, so this in turn permits an accurate and predetermined fiber arrangement on the base part.

In particular multiple layers of reinforcing fibers arranged side-by-side may be applied to the base part. The height of rise may be 0.4 mm, for example, but only half a fiber length per layer is necessary—Lₘₐₓ requirement.

According to one embodiment of the invention, a capping part, in particular made of the metal forming the metal layer of the reinforcing fibers, is shrunk onto the free ends of the wound base part. Furthermore, the outer layer may be covered with another metal layer such as a metal ring shrunk onto it.

The base part is preferably designed as a rotationally symmetrical body. The fiber gaps are 30 μm in the case of a round fiber, for example, and 100 μm in the case of a reinforcing fiber according to this invention, e.g., with a hexagonal exterior shape.

The ends of the reinforcing fibers run at a 45° angle at the axial end face/near the surface. Due to the subsequent rays of the sphere, this results in a pressure Es at the end of the fiber.

The reinforcing fiber can be produced according to one embodiment of this invention by passing a ceramic fiber and two metal films through a double roller having a polygonal profile for the exterior shape.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a schematic perspective view of two rollers and a reinforcing fiber used to form an embodiment of the present invention;

FIG. 2 shows a cross section through the rollers with the reinforcing fiber of FIG. 1;

FIG. 3 shows a base part having grooves onto which the reinforcing fiber formed with the rollers of FIG. 1 is coiled;

FIG. 4 shows the reinforcing fiber in FIG. 1 before and after stamping a polygonal exterior shape, and

FIG. 5 shows multiple rollers stamp a polygonal exterior shape onto a reinforcing fiber according to an alternative embodiment of this invention.

### DETAILED DESCRIPTION

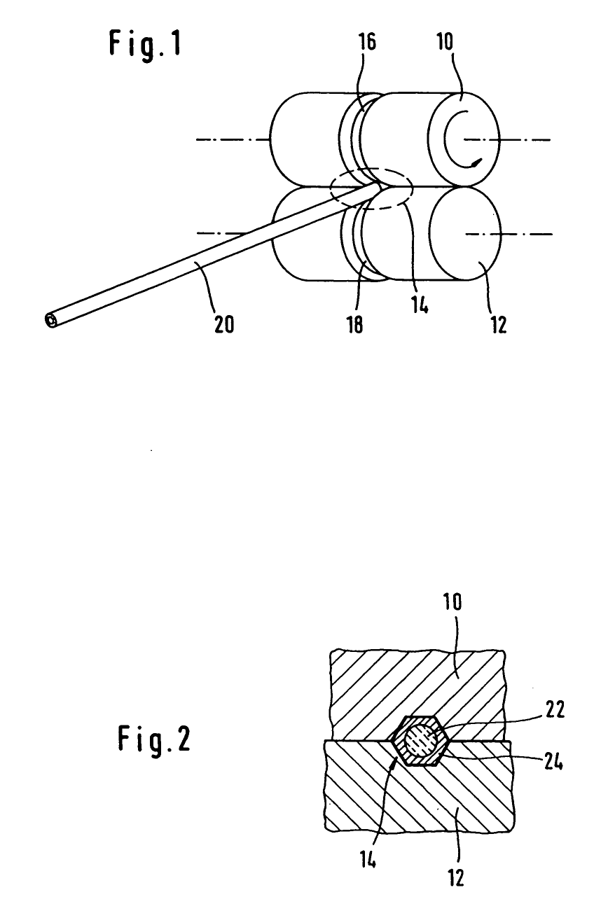

FIG. 1 shows two rollers 10 and 12 diagrammed schematically. The rollers 10 and 12 are designed so they correspond to one another and have polygonal recesses 16 and 18 that are paired together in the roller area 14. The two polygonal recesses 16 and 18 paired together stamp a hexagonal exterior shape onto a reinforcing fiber 20 inside a metal layer 24 surrounding a ceramic fiber 22 (see FIG. 2).

The reinforcing fiber 20 is comprised of the ceramic fiber 22 and the metal coating 24. The ceramic fiber 22 has a round exterior shape in cross section before the polygonal exterior shape is stamped and it has a circular metal coating 24 applied to it. The metal coating 24 is applied by a PVD process. The ceramic fiber 22 is a silicon carbide fiber. The metal coating 24 is a titanium alloy. The ceramic fiber 22 has a diameter of 140 μm, for example, with a metal coating 24 of 30 μm (see FIG. 4).

After shaking the reinforcing fiber 20 into a hexagonal exterior shape (see FIG. 4) the length a is approx. 110 μm and the length b is approx. 190 μm.

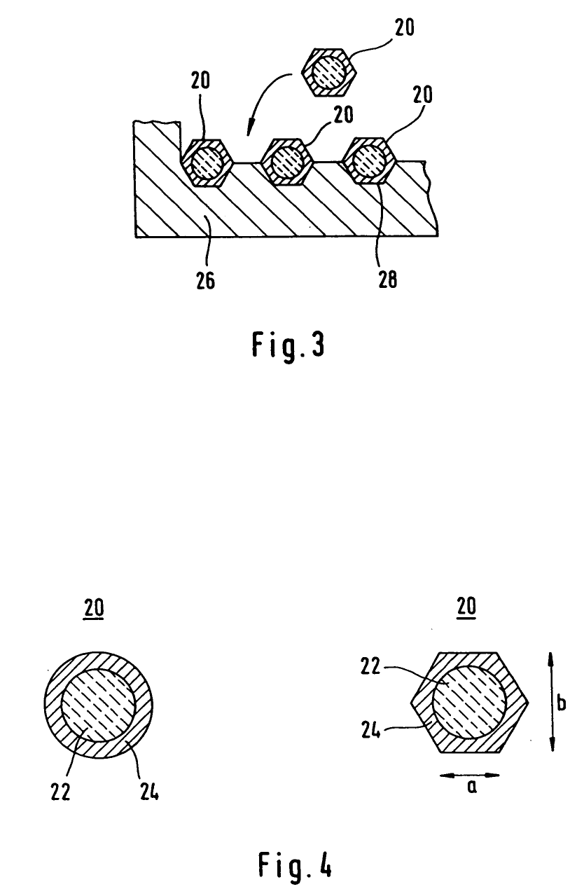

After stamping the hexagonal exterior shape, the reinforcing fiber 20 is coiled onto a rotationally symmetrical base part 26 (see FIG. 3). The surface of the base part 26 has grooves 28 which are adapted to the polygonal exterior shape such that half of the reinforcing fibers 20 can be introduced into the groove 28. The groove 28 runs in a spiral on the surface thus forming an endless coil. If the first layer of reinforcing fibers 20 has been introduced into the groove 28 according to diagram in FIG. 3, then an additional layer of reinforcing fibers 20 is introduced into the interspaces between the adjacent reinforcing fibers 20. The additional layer of reinforcing fibers 20 is then in direct contact with the first layer of reinforcing fibers 20 without any cavity and is in contact with the surface of the base part 26. The grooves 28 are introduced in a spiral pattern into the surface of the base part 26 with a spacing between them.

Due to the application of the reinforcing fibers 20 to the base part 26 in multiple layers, a composite structure comprising multiple reinforcing fibers 20 arranged side-by-side and above one another without any cavities is formed. Then the composite structure is compressed with the base part in a hot isostatic pressing operation which does not result in any volume shrinkage or the disadvantages associated therewith.

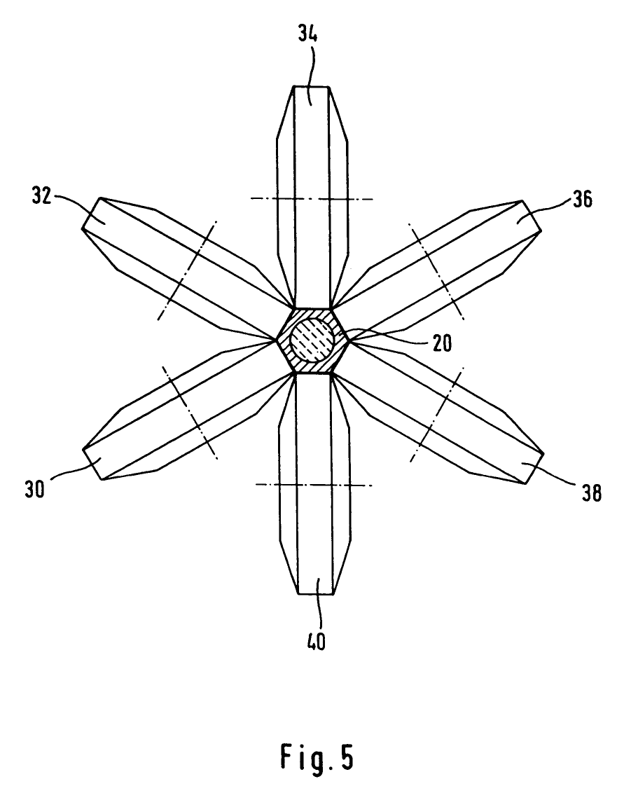

FIG. 5 shows an arrangement of six rollers 30, 32, 34, 36, 38 and 40. Each rollers 30 through 40 is assigned a face of the polygonal exterior shape of the reinforcing fibers 20. With the help of the rollers 30 through 40 the reinforcing fiber 20 is converted from an exterior shape having a round cross section to an exterior shape having a polygonal cross section, in this case a hexagonal exterior shape which thus yields the advantages cited above.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Method for producing a ceramic fiber with a metal coating, wherein the metal coating on the ceramic fiber is converted to an exterior shape having a polygonal cross section which permits an arrangement of reinforcing fibers side-by-side and above one another without any cavities.

2. Method as claimed in claim 1, wherein the polygonal exterior shape is stamped on the metal coating by cold rolling.

3. Method as claimed in claim 1 wherein the polygonal exterior shape is a hexagonal cross section.

4. Method as claimed in claim 1, wherein the ceramic fiber is first provided with a metal coating and then the polygonal exterior shape is formed.

5. Method as claimed in claim 4, wherein the metal coating has an essentially constant thickness over the circumference before forming the shape.

6. Method as claimed in claim 1, wherein the metal coating is applied to the ceramic fiber by a physical vapor deposition process or by rolling a metal wire onto the ceramic fiber when the fiber is hot under a protective gas atmosphere.

7. Method as claimed in claim 1, wherein Ti64 titanium is used as the metal coating.

8. Method as claimed in claim 1, wherein the ceramic fibers include the elements silicon, carbon, boron, oxygen, aluminum and nitrogen.

9. Method as claimed in claim 1, wherein the reinforcing fiber is applied to a base part for form a metal-matrix component.

10. Method for producing a semifinished product with a plurality of reinforcing fibers produced by a method as claimed in claim 1, wherein the ceramic fibers are wound onto a base part without any cavities.

11. Method as claimed in claim 10, wherein the base part has grooves in its surface into which the ceramic fibers are introduced.

12. Method as claimed in claim 10, wherein after winding the reinforcing fibers onto the base part hot isostatic pressing is performed.

13. Method as claimed in claims 10, wherein multiple layers of reinforcing fibers arranged side by side are applied to the base part.

14. Method as claimed in claims 10, wherein a capping part is shrunk onto the free ends of the wound base part.

15. Method as claimed in claim 10, wherein the base part is designed as a rotationally symmetrical body.
